(19) United States
(12) Patent Application Publication
(10) Pub. No.: US 2020/0094654 A1
(43) Pub. Date: Mar. 26, 2020

(54) FLUID HEATING DEVICE AND METHOD FOR THE PRODUCTION THEREOF

(71) Applicant: Webasto SE, Stockdorf (DE)

(72) Inventors: MARTIN ZOSKE, Stockdorf (DE); VOLODOMYR ILCHENKO, Stockdorf (DE); CHRISTOPH JÖRG, Stockdorf (DE); BENGT MEIER, Stockdorf (DE); MINA KROMPIC, Stockdorf (DE); PATRICK SPIELBERGER, Stockdorf (DE)

(21) Appl. No.: 16/615,470

(22) PCT Filed: May 24, 2018
(86) PCT No.: PCT/EP2018/063726

§ 371 Date: Nov. 21, 2019

(30) Foreign Application Priority Data
May 24, 2017 (DE) 10 2017 111 373.8
May 24, 2017 (DE) 10 2017 111 378.9
Jul. 6, 2017 (DE) 10 2017 115 148.6
Sep. 12, 2017 (DE) 10 2017 121 040.7
Sep. 12, 2017 (DE) 10 2017 121 041.5
Sep. 12, 2017 (DE) 10 2017 121 045.8
Sep. 12, 2017 (DE) 10 2017 121 060.1

(51) Int. Cl. B60H 1/22; F24H 3/04; F24H 1/10; F24H 1/12; F24H 1/20; H05B 3/14

(52) U.S. Cl. CPC B60H 1/2225; B60H 1/2218; F24H 3/04; F24H 1/103; F24H 1/121; H05B 2203/017; F24H 3/0429; H05B 3/146; F24H 2250/04; H05B 2203/02; H05B 2203/023; F24H 1/202

(57) ABSTRACT

A method for producing an electrical fluid heater, in particular an air heater for a motor vehicle, including at least one fluid guiding channel for the fluid to be guided through, wherein at least one conductive polymer structure containing a polymer component and a conductive component, in particular carbon component, is coated, in particular cohesively, with at least one metallic layer.

### CROSS-REFERENCE TO RELATED APPLICATIONS

This application represents the national stage entry of PCT International Patent Application No. PCT/EP2018/063726 filed on May 24, 2018 and claims priority to German Patent Application No. DE 10 2017 111 373.8 filed May 24, 2017, German Patent Application No. DE 10 2017 111 378.9 filed May 24, 2017, German Patent Application No. DE 10 2017 115 148.6 filed Jul. 6, 2017, German Patent Application No. DE 10 2017 121 040.7 filed Sep. 12, 2017, German Patent Application No. DE 10 2017 121 041.5 filed Sep. 12, 2017, German Patent Application No. DE 10 2017 121 060.1 filed Sep. 12, 2017, and German Patent Application No. DE 10 2017 121 045.8 filed Sep. 12, 2017. The contents of each of these applications are hereby incorporated by reference as if set forth in their entirety herein.

### DESCRIPTION

The disclosure relates to a fluid heater and to a method for producing same.

Electrical air heaters (in particular those used in mobile applications) are usually based on ceramic heating elements having a comparatively highly temperature-dependent electrical resistance, which enables self-regulation of the heat output. These resistors are usually ceramic PTC elements (PTC stands for Positive Temperature Coefficient). The latter can be connected to heat exchanger areas composed of sheet aluminium and can also be electrically contacted via the latter. A PTC element comprises a PTC resistor, that is to say a temperature-dependent resistor having a positive temperature coefficient, which conducts the electric current better at low temperatures than at high temperatures. Mechanical and electrical linking of the PTC elements can be effected for example by clamping to the heat exchanger.

Disadvantages of conventional air heaters having ceramic PTC elements are, inter alia, complex production on account of comparatively complicated heat exchanger manufacture and comparatively complex assembly of individual heating elements and heat exchanger sheets, in particular with regard to the electrical contacting of the heating elements; sorting of the ceramic elements that is usually necessary on account of manufacturing tolerances; a comparatively low heating power as a result of local heat generation and/or inhomogeneous temperature distribution in the ceramic elements (a low temperature gradient between heating element surface and heat exchanger sheet); a comparatively high risk of short circuit, in particular on account of a small geometric spacing of components having a high voltage difference; and contacting of the heating elements which exhibits little process reliability.

It is an object of the disclosure to propose an easily implementable method for producing an efficient fluid heater, in particular air heater for a motor vehicle. Furthermore, it is an object of the disclosure to propose a fluid heater, in particular air heater for a motor vehicle, which operates efficiently and is simple to produce. In accordance with further aspects, the intention is also to propose a corresponding motor vehicle, a corresponding method for operating a fluid heater and also a use of a fluid heater.

This object is achieved in particular by means of a method according to claim 1.

In particular, the object is achieved by means of a method for (or of) producing an electrical fluid heater, in particular an air heater (or alternatively liquid, in particular water, heater) for a vehicle, preferably motor vehicle, more preferably car or lorry (or else ship or aeroplane), comprising preferably at least one fluid guiding channel for the fluid to be guided through, wherein at least one conductive polymer structure containing a polymer component and a conductive component, in particular carbon component, is coated, in particular cohesively, with at least one metallic layer. The method can comprise, as a method step, forming the at least one fluid channel.

A cohesive bond should be understood to mean, in particular, a connection in which the connection partners are held together by atomic and/or molecular forces. Preferably, the connection is non-releasable (or not releasable non-destructively, i.e. without, in particular irreversible, destruction of the connection partners). A force-locking and/or positively locking engagement can also be present in addition to a cohesive bond. In embodiments, however, optionally exclusively a cohesive bond is present. Furthermore, a cohesive bond is intended to be present in particular if adhering to one another over at least 50%, more preferably at least 80%, optionally (at least approximately) 100%, of a contact area is ensured between the connection partners.

A central concept of the disclosure is to provide a metallic layer as contacting and/or heat transfer layer and to connect it, in particular cohesively, to the polymer structure. As a result, a comparatively compact and efficiently operating heater can be produced in a simple manner. In particular, simple and readily automatable contacting (suitable for mass production) between metal and polymer structure is made possible. A (mechanical) connection between polymer structure and metallic layer is preferably comparatively durable and long-lived. Overall, in particular a thin contacting structure with a low weight associated therewith can be achieved. A contact resistance between metallic layer and polymer structure is low. The metal layer furthermore preferably enables a soldering connection to a contact electrode, which simplifies the production method overall.

A fluid heater or air heater should be understood to mean, in particular, a heater which is embodied as an assembly (structural unit). The fluid heater or air heater can be delimited towards the outside by a corresponding housing. The polymer structure, the at least one connection electrode and the at least one fluid channel are then preferably provided within said housing. A volume of the fluid heater can be less than 2500 cm³, preferably less than 1000 cm³. Furthermore, the fluid heater can have a fluid inlet and a fluid outlet, through which the fluid (in particular the air) can flow in and out, respectively. As an alternative to the embodiment as an air heater, the fluid heater can also be embodied (for mobile applications) as a liquid heater, in particular a water heater.

A metallic layer should be understood to mean, in particular, a layer comprising at least 50% by weight, preferably at least 80% by weight, more preferably at least 95% by weight, of metal(s). The metallic layer can also be constructed at least substantially completely from metal(s). The metallic layer can be embodied homogeneously (that is to say in particular without local material and/or density fluctuations) or inhomogeneously. Furthermore, the metallic layer can be embodied monolithically. The metallic layer can be structured or unstructured. Furthermore, the (respective) metallic layer (assigned to a specific polymer structure which is per se integral or continuous, in particular) can be constructed from (only) one or a plurality of separate (each intrinsically continuous) part(s). The metallic layer can have at least substantially a constant thickness. In so far as the thickness fluctuates, a maximum thickness is preferably not greater than a minimum thickness plus 20% (or plus 10%) of the minimum thickness. Furthermore, the (respective) metallic layer can cover at least 50%, preferably at least 80%, more preferably at least 90%, of a (planar) area of the polymer structure. Overall, at least 50%, preferably at least 80%, more preferably at least 90%, of a (total) surface area of the (respective total continuous) polymer structure can be covered with one or a plurality of metallic layer(s).

The metallic layer is preferably cohesively connected to the polymer structure at least substantially over the whole area (or to the extent of at least 50% or to the extent of at least 80%) (with respect to an area facing the polymer structure). A particularly strong composite and efficient operation of the fluid heater can be made possible as a result.

The metallic layer at least partly, in particular (in terms of weight and/or area) predominantly or completely, can be constructed (firstly) on the polymer structure. Alternatively or additionally, the metallic layer at least partly, in particular (in terms of weight and/or area) predominantly or completely, preferably as a film, can be or have been completed already before being connected to the polymer structure, wherein the metallic layer (or the prefabricated portion thereof) is then pretreated, in particular roughened, preferably before being connected to the polymer structure. The adhesion (intermeshing) with the polymer structure can be improved as a result of such a pretreatment.

The metallic layer preferably has a layer thickness of at least 10 nm, preferably at least 100 nm, more preferably at least 1 μm, more preferably at least 10 μm, if appropriate at least 25 μm, and/or at most 2 mm, preferably at most 500 μm, more preferably at most 200 μm, more preferably at most 150 μm, if appropriate at most 50 μm or at most 20 μm or at most 15 μm.

The metallic layer preferably at least partly comprises copper or a copper alloy.

In embodiments, a surface of the polymer structure can be pretreated, in particular structured, preferably in such a way that the conductive component (in particular conductive particles at least partly forming the conductive component) of the polymer structure is (are) at least partly uncovered. As a result, a good (mechanical and/or electrical) contact between polymer structure and metallic layer can be achieved in a simple manner.

The metallic layer is preferably connected to a contact electrode, in particular by soldering, and/or embodied as an intermediate layer between polymer structure and a/the contact electrode. The contact electrode can be an electrical lead, e.g. comprising a wire section and/or a pad.

The metallic layer is preferably applied at least partly by spraying, in particular thermal spraying, and/or lamination, in particular thermal lamination and/or lamination by way of (a preferably conductive) adhesion promoter, and/or vapour deposition, in particular by way of PVD (PVD stands for Physical Vapour Deposition), and/or by electroplating and/or by welding, preferably ultrasonic welding.

In accordance with the embodiment, the (respective) metallic layer is applied (at least partly) in a thermal spraying method. In the case of thermal spraying, the material to be applied is firstly melted before being applied (by way of a gas flow; in a particulate fashion) to that surface of the polymer structure which is to be coated. In this case, the metallic layer can be produced over a comparatively wide range of possible layer thicknesses and adheres well on the polymer structure, only a comparatively low electrical contact resistance occurring at a material boundary. A metallic layer produced in a thermal spraying method is particularly well suited as an electrical connection layer between polymer structure and contact electrode, in particular for heaters in which a good current-carrying capacity of a contact layer is required.

In embodiments, a metallic film can be laminated onto the polymer structure. In this case, the material of the polymer structure is preferably melted thermally at the surface, in particular in order to achieve or to improve a mechanical and/or electrical connection between the metal film and the material of the polymer structure. The metal film can be applied by pressing the metal film onto the polymer structure surface with pressure being applied. The metal film can comprise copper or a copper alloy, for example. A layer thickness can be at least 30 μm and/or at most 110 μm. A surface of the metal film can be pretreated (roughened) with regard to its surface constitution at least on a contact side with respect to the polymer structure. The surface treatment of the metal film preferably produces a rough surface structure that brings about in particular an intermeshing of the material of the polymer structure with a surface of the metal film. The intermeshing and/or the comparatively large contact surface area can enable a low electrical contact resistance and also a good mechanical adhesion between the polymer structure and the metal film. If appropriate, a/the surface of the material of the polymer structure can be pretreated by means of a corresponding method in such a way that the conductive structures (in particular conductive filler particles) embedded into the polymer matrix at the surface are at least partly uncovered and an improved electrical contact can thus be produced.

In further embodiments, a metal film can be laminated (at least partly) onto the polymer structure (for electrical contacting) by means of an adhesion promoter. Via the applied metal film, the polymer structure can be connected to a (contact) electrode and be reliably electrically contacted therewith. The adhesion promoter (adhesive) can provide for a good mechanical and/or electrical connection between metal film and polymer structure. In order to ensure or to improve an electrical contact, optionally an electrically conductive adhesive can be used as adhesion promoter. An electrically non-conductive adhesive is also conceivable in principle. An electrical contact must then be ensured if appropriate in some other way (for example by particularly thin embodiment of the adhesive layer and/or by regions remaining free in part, in which no adhesive layer is provided). The layer thickness can be at least 30 μm and/or at most 110 μm, wherein a surface can be pretreated with regard to its surface constitution on a contact side towards the polymer structure. The surface treatment of the metal film can produce in particular a rough surface structure that preferably brings about an intermeshing of the adhesion promoter with the film surface. Intermeshing and large contact surface area bring about a low electrical contact resistance and a comparatively good mechanical adhesion between the polymer structure and the metal film. Here, too, the surface of the polymer structure can preferably be pretreated by means of a corresponding method in order at least partly to uncover the conductive structures (in particular filler particles) embedded into a polymer matrix at a surface and thus to produce a good electrical contact.

In further embodiments, the metallic layer can be applied (at least partly) to the polymer structure in a PVD method. The PVD method (PVD stands for Physical Vapour Deposition) denotes the physical deposition of thin metal layers by way of the vapour phase. The applied layer can be made very thin (optionally thinner than 15 μm) and adheres comparatively well on the material of the polymer structure, only a low electrical contact resistance occurring at the material interface. Therefore, a metal layer produced in a PVD method is particularly well suited as an electrical intermediate layer between the polymer structure and at least one contact electrode, in particular for heating elements in which a good current-carrying capacity of the contact layer is required. A surface treatment of the polymer structure can be carried out under vacuum conditions, optionally in a plasma method, and ensure a low contact resistance at the interface between the two materials.

In embodiments, the metallic layer can be applied (at least partly) to the polymer structure by means of an electroplating method. This is an electrolytic process. It is possible to produce metallic coatings on the polymer structure by electrochemical deposition. The applied layer can optionally be made comparatively thin (for example up to 50 μm) and adheres well on the polymer structure, only a low electrical contact resistance occurring at a material interface. The metal layer produced by electroplating is particularly suitable as an electrical intermediate layer between polymer structure and contact electrode, in particular for heaters in which a good current-carrying capacity of the contact layer is required without the material of the polymer structure being thermally damaged during the production process. In particular, a good electrical contact between the metallic layer and the polymer structure, in particular a conductive component (conductive particles) of the polymer structure, can be achieved by means of such a method.

Furthermore, the metallic layer can be applied (at least partly) to the polymer structure by means of ultrasonic welding. Ultrasonic welding is understood to be a welding method which connects the two joining partners to one another by means of high-frequency mechanical vibrations. The ultrasonic process can proceed intermittently, semi-continuously or continuously. In this regard, e.g. a corresponding sonotrode can be shaped as a stamp or as a rotating roller. The surface of the metallic layer (e.g. metallic film) before being applied to the polymer structure can be structured, activated and/or roughened in order to improve adhesion. Connecting by means of ultrasound makes it possible to achieve a reliable connection between polymer structure and metallic layer, in particular without the material of the polymer structure being thermally damaged during the production process. In particular, a good electrical contact between the metallic layer and the polymer structure, in particular a conductive component (conductive particles) of the polymer structure, can be achieved by means of such a method. Ultrasonic welding is implementable with process reliability and is suitable for mass production. It is possible with preference also to use polymeric materials which melt with difficulty or do not melt at all and/or which react negatively to increased heat action.

One sonotrode or a plurality of sonotrodes can be embodied as stamp(s) and/or as rotating roller(s). In one concrete embodiment, two sonotrodes are provided in order to connect the polymer structure to a corresponding connection electrode on both sides. The two sonotrodes can then be arranged opposite one another, such that during the method the polymer structure and the electrodes to be connected thereto lie between the two sonotrodes. In this case, in particular, the sonotrodes can be configured as rotating rollers.

In accordance with a further aspect of the disclosure, the above object is achieved in particular by means of an electrical fluid heater, in particular air heater (alternatively liquid heater, in particular water heater), for a vehicle, in particular motor vehicle, preferably produced according to the method described above, preferably comprising at least one fluid guiding channel, at least one conductive polymer structure containing a polymer component and a conductive component, in particular carbon component, and also at least one metallic layer connected, in particular cohesively, to the polymer component.

In embodiments, the present structure can be embodied dimensionally stably (in a self-supporting fashion) at least in sections, optionally completely. The polymer structure is optionally embodied as a (solid) block. A thickness of the polymer structure can be at least 1 mm or at least 3 mm. Alternatively or additionally, the polymer structure can have been or be embodied flexibly, preferably as a film or strip (or an arrangement of a plurality of strips), at least in sections, optionally completely. If the polymer structure is embodied both dimensionally stably (in sections) and flexibly (in sections), the polymer structure can be embodied (in terms of weight) either predominantly dimensionally stably or predominantly flexibly. A flexible embodiment should be understood to mean, in particular, an embodiment in which the polymer structure does not maintain its shape if it is placed onto an uneven surface or is placed only at an edge. In this case, in particular, the polymer structure can have a thickness of less than 0.1 mm, preferably less than 0.01 mm.

The conductive component, in particular carbon component, can be present in particle form and/or as a (carbon) scaffold (skeleton). The carbon component can be present in the form of carbon black and/or graphite and/or graphene and/or carbon fibres and/or carbon nanotubes.

The polymer structure can comprise an electrically insulating polymer component.

The metallic layer is preferably applied at least partly by spraying, in particular thermal spraying, and/or lamination, in particular thermal lamination and/or lamination by way of a preferably conductive adhesion promoter, and/or vapour deposition, in particular by way of PVD, and/or by electroplating and/or by welding, in particular ultrasonic welding.

In accordance with a further aspect of the disclosure, the above object is achieved, in particular, by means of a method for operating a fluid heater of the above type and/or produced according to the method of the above type, wherein fluid, in particular air, flows through the fluid heater and is heated in the process.

In accordance with a further aspect of the disclosure, the above object is achieved, in particular, by the use of a fluid heater of the above type or produced according to a method of the above type for heating a fluid, preferably air, in particular in a motor vehicle, preferably for a motor vehicle interior.

The polymer structure (particularly if it is embodied as non-self-supporting) can be applied, for example coated (printed), onto a substrate (which is optionally electrically insulating and/or electrically insulated from the polymer structure). For the purpose of coating, by way of example, a screen printing method or else blade coating can be used. Such a substrate can simultaneously be used as a heat exchanger area for heating the fluid flowing past (the air flowing past). Optionally, this surface area can also be enlarged by unevennesses, in particular projections, such as ribs and/or fins, on the substrate.

The substrate or the substrates can be fabricated from plastic, in particular a polymer such as, for example, polyether ketone and/or polyamide, at least in sections, preferably completely. Particular preference is given to fabrication from polyethylene (PE) and/or polypropylene (PP) and/or polyether ether ketone (PEEK) and/or (short-) fibre-reinforced polyamide (e.g. PA-GF).

The substrate can be fabricated from an electrically insulating material. An electrically insulating material should be understood to mean, in particular, a material which has an electrical conductivity of less than 10-1 S·m−1 (optionally less than 10-8 S·m−1) at room temperature (25° C.). Accordingly, an electrical conductor or a material (or coating) having electrical conductivity should be understood to mean a material having an electrical conductivity of preferably at least 10 S·m−1, more preferably at least 103 S·m−1 (at room temperature of, in particular, 25° C.).

The substrate can be embodied as a plate, in particular a plastic plate, and/or have a thickness of at least 0.1 mm, preferably at least 0.5 mm, more preferably at least 1.0 mm, and/or at most 5.0 mm, more preferably at most 3.0 mm. The respective thickness is, in particular, an average thickness or a thickness of the largest region with constant thickness.

The polymer structure (e.g. polymer coating) and/or a corresponding paste for its production can comprise (as, in particular, crystalline binder) at least one polymer, preferably based on at least one olefin; and/or at least one copolymer of at least one olefin and at least one monomer which can be copolymerized therewith, e.g. ethylene/acrylic acid and/or ethylene/ethyl acrylate and/or ethylene/vinyl acetate; and/or at least one polyalkenamer (polyacetylene or polyalkenylene), such as e.g. polyoctenamer; and/or at least one, in particular melt-deformable, fluoropolymer, such as e.g. polyvinylidene fluoride and/or copolymers thereof.

The polymer structure (e.g. polymer coating) can have been or be cured in a furnace (at elevated temperature).

The (respective) polymer structure (e.g. polymer coating) is preferably in contact with the (respective) substrate over at least 20%, more preferably at least 50%, even more preferably at least 80%, of a surface of the substrate facing the polymer structure (e.g. polymer coating). As a result, heat can be effectively transferred via the substrate (which then serves as a further heat exchanger).

In general, the polymer structure (e.g. polymer coating) can have a continuous area (without interruptions) or be structured, for example have gaps (perforations) or cutouts.

Preferably, the polymer structure (e.g. polymer coating) comprises at least 5% by weight, preferably at least 10% by weight, even more preferably at least 15% by weight, even more preferably at least 20% by weight, and/or less than 50%, of carbon (if appropriate without taking into account a carbon fraction of the polymer as such) or of the carbon component, such as e.g. the carbon particles.

The respective polymer structure (e.g. polymer coating) can be thinner (at least on average) than a corresponding substrate, for example by a factor of 1.1; more preferably by a factor of 1.5.

In principle, the term “conductive” with regard to the conductive components of the air heater should be understood as an abbreviation of “electrically conductive”.

The (respective) polymer structure (e.g. polymer coating) is preferably a conductive layer having PTC behaviour.

The fluid heater is preferably designed for operation in the low-voltage range (e.g. ≤100 volts or ≤60 volts). Alternatively, the fluid heater can be designed for the high-voltage range (e.g. >100 volts, preferably >400 volts, optionally greater than 800 V).

The air heater can be designed for operation with DC and/or AC voltage and/or PWM.

A (layer) thickness of the respective polymer structure (e.g. polymer coating) can be ≤1 mm, preferably ≤0.5 mm, even more preferably ≤0.2 mm.

The polymer structure (e.g. polymer coating) and/or the substrate can be embodied as at least substantially planar. If elevations (depressions) are provided, they can amount to less than 10% of an (average) thickness of the respective coating and/or of the respective substrate.

The carbon fraction in the polymer structure (e.g. polymer coating) can be embodied such that it allows a current flow (e.g. in particle form, the particles correspondingly touching one another or being close together).

At least 3, preferably at least 5, heating elements can be provided, each comprising a dedicated polymer structure and optionally one or two or more metallic layer(s).

In accordance with a further (optionally independent) aspect of the disclosure, the above object is achieved by means of a heating element having the features explained above and/or below. The heating element can completely or partly form the fluid channels mentioned or can be embodied (per se) without fluid channels. In the latter case, corresponding fluid channels can then optionally arise during the assembly of a plurality of heating elements during the production of the fluid heater.

Further embodiments are evident from the dependent claims.

The disclosure is described below on the basis of exemplary embodiments which are explained in greater detail with reference to the accompanying figures, in which:

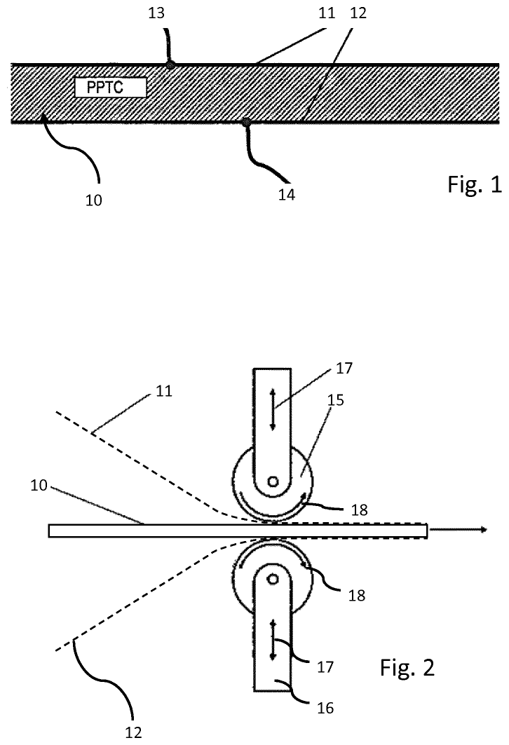

FIG. 1 shows a schematic excerpt from a fluid heater according to the disclosure; and

FIG. 2 shows a schematic illustration of a method for producing a fluid heater according to the disclosure.

In the following description, the same reference signs are used for identical and identically acting parts.

FIG. 1 shows an excerpt from one embodiment of a fluid heater according to the disclosure. The fluid heater comprises an electrically conductive polymer structure 10 composed of a PPTC material, a first metallic layer 11 on a first side of the polymer structure 10, and a second metallic layer 12 on a second (opposite) side of the polymer structure 10. The metallic layers are cohesively connected to the polymer structure preferably over the whole area. Furthermore, the metallic layers 11, 12 are in each case connected to a connection electrode (contact electrode) 13 and 14, respectively, such that an electric current can flow through the polymer structure 10 via the metallic layers 11, 12.

FIG. 2 shows a polymer structure 10, which is connected on both sides to a first metallic layer 11 and a second metallic layer 12. This takes place here in a continuous method. For this purpose, the arrangement of the polymer structure 10 with the two metallic layers (metal films) 11, 12 is brought between two sonotrodes 15, 16. Ultrasonic welding is then carried out by means of a corresponding ultrasound-induced movement in accordance with the arrows 17. The arrows 18 indicate a direction of rotation of the roller-type sonotrodes 15, 16. The material for the metallic layers 11, 12 can for example be unrolled from a storage roll and/or be correspondingly guided in the direction of the polymer structure 10 by deflection rolls (not shown in FIG. 1).

It should be pointed out at this juncture that all parts described above, considered by themselves and in any combination, in particular the details illustrated in the drawings, are claimed as essential to the disclosure. Modifications thereof are familiar to the person skilled in the art.

### LIST OF REFERENCE SIGNS

10 Polymer structure
11 Metallic layer
12 Metallic layer
13 Contact electrode
14 Contact electrode
15 Sonotrode
16 Sonotrode
17 Arrow
18 Arrow

1. Method for producing an electrical fluid heater for a motor vehicle, comprising at least one fluid guiding channel for the fluid to be guided through, wherein at least one conductive polymer structure containing a polymer component and a conductive component is coated with at least one metallic layer.

2. Method according to claim 1,
wherein
the metallic layer is cohesively connected to the polymer structure at least substantially over the whole area.

3. Method according to claim 1,
wherein
the metallic layer at least partly is constructed firstly on the polymer structure and/or at least partly as a film, is or has been completed already before being connected to the polymer structure, wherein the metallic layer has been or is pretreated before being connected to the polymer structure.

4. Method according to claim 1, wherein
the metallic layer has a layer thickness of at least 10 nm.

5. Method according to claim 1, wherein
the metallic layer at least partly comprises copper or a copper alloy.

6. Method according to claim 1, wherein
a surface of the polymer structure is pretreated in such a way that the conductive component of the polymer structure is/are at least partly uncovered.

7. Method according to claim 1 wherein
the metallic layer is connected to a contact electrode and/or is embodied as an intermediate layer between polymer structure and contact electrode.

8. Method according to claim 1, wherein
the metallic layer is applied at least partly by spraying and/or lamination, and/or vapour deposition, and/or by electroplating and/or by welding.

9. Electrical fluid heater for a motor vehicle produced by the method according to claim 1, comprising at least one fluid guiding channel, at least one conductive polymer structure containing a polymer component and a conductive component and also at least one metallic layer connected to the polymer component.

10. Fluid heater according to claim 9, wherein
the polymer structure is embodied dimensionally stably at least in sections and/or flexibly at least in sections.

11. Fluid heater according to claim 9,
wherein
the conductive component is present in particle form and/or as a scaffold and/or is present in the form of carbon black and/or graphite and/or graphene and/or carbon fibres and/or carbon nanotubes, and/or
the polymer structure comprises an electrically insulating polymer component.

12. Fluid heater according to claim 9,
wherein
the metallic layer is applied at least partly by spraying and/or lamination, and/or vapour deposition, and/or by electroplating and/or by ultrasonic welding.

13. Method for operating a fluid heater according to claim 9, wherein fluid flows through the fluid heater and is heated in the process.

14. (canceled)

15. Method according to claim 1, wherein the fluid is air.

16. Method according to claim 1, wherein the conductive component is a carbon component.

17. Method according to claim 3, wherein the metallic layer is pretreated by roughening the metallic layer

18. Fluid heater according to claim 9, wherein the polymer structure is embodied dimensionally stably at least in sections as a block, and/or flexibly at least in sections as a film.

19. Method according to claim 1, wherein the metallic layer is applied at least partly by thermal spraying, and/or thermal lamination and/or lamination by way of a conductive adhesion promoter, and/or PVD vapour deposition, and/or by ultrasonic welding.

20. Fluid heater according to claim 9, wherein the metallic layer is applied at least partly by thermal spraying, and/or thermal lamination and/or lamination by way of a conductive adhesion promoter, and/or PVD vapour deposition, and/or by ultrasonic welding.

21. Method according to claim 1 wherein the metallic layer is soldered to a contact electrode.
